(19) United States
(12) Patent Application Publication
(10) Pub. No.: US 2019/0217994 A1
(43) Pub. Date: Jul. 18, 2019

(54) SACK

(71) Applicant: YOZGAT KRAFT TORBA SANAYI VE TICARET ANONIM SIRKETI, Ankara (TR)

(72) Inventor: Cengiz Han DURUDUYGU, Ankara (TR)

(21) Appl. No.: 16/359,058

(22) Filed: Mar. 20, 2019

Related U.S. Application Data
(63) Continuation-in-part of application No. 15/468,933, filed on Mar. 24, 2017, now abandoned.

(30) Foreign Application Priority Data
Mar. 25, 2016 (TR) 2016/03887

(51) Int. Cl. B65D 30/08; B65D 30/24; B32B 15/20; B32B 15/12; B32B 27/32; B65D 30/18

(52) U.S. Cl. CPC B65D 31/02; B65D 31/145; B32B 15/20; B32B 15/12; B32B 2307/7244; B65D 31/08; B32B 2439/46; B32B 2250/03; B32B 2307/7265; B32B 27/32

(57) ABSTRACT

A sack which stores granular and/or powder-sized materials, which gives the inside air to the outside when the granule and/or powder material is filled. With the disclosed sack, internal air is provided to the outside when the material is filled in the interior of the ventilation channel with a ventilation channel between the intermediate layers, consisting of more than one intermediate layer and the physical and chemical properties of the products in powder and/or granular form are kept unchanged and stored.

### CROSS-REFERENCE TO RELATED APPLICATIONS

The present application is a continuation-in-part of U.S. application Ser. No. 15/468,933, filed on Mar. 24, 2017, and entitled “Kraft Sacks Used to Store Industrial-purpose Dust and Granule Products”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to a sack in which the air extends into the kraft sack in the valve orifice region located at the bottom or top of the kraft sack, while maintaining the granular and/or powder size materials, into which the granular and/or powder material is filled and provides dust and easy filling and also prevents the moisture and odor permeability with its kraft structure.

2. Description of Related Art Including Information Disclosed Under 37 CFR 1.97 and 37 CFR 1.98.

Nowadays, products in the form of powder and/or granules are produced according to the needs of various applications. Powder and/or granule-tight sacks are used for the storage and packaging of products in powder and/or granule form. The sacks used in the storage of products in the form of granule and/or powder are also produced from kraft paper or from various chemical compositions. Storage and/or preservation sacks produced from kraft paper are more preferred in industrial areas due to their ease of use and environment friendly form. In addition, since the kraft paper contains cellulose fibers, which makes it more durable, which means that the kraft paper is more difficult to tear.

In the state of the art, product exits and outings are caused by evacuation holes on the packaging surface during the evacuation of the air entering the package during the filling of the products. In the state of the art, since the dusty parts of the products are easily suspended in the air, the filling processes are sometimes disordered. Therefore, due to the outing during filling, it causes the air in the environment to pollute and also creates a health hazard for the personnel in the filling area. In addition, due to the vibrations during the transport of the filled sacks, the fine dust material in the sack exits through the holes in the sack surface and from the filling orifice. Special valves have been developed to ensure that the filling orifices of the sack are firmly connected to the dispensing orifice in order to prevent the fine dust from overflowing and/or leakage. Thanks to these valves, the dispensing of the powder material in the sack is prevented from being removed from the sack after the dispensing orifice has been removed from the filling orifice.

In the state of the art, kraft paper consisting of a plurality of intermediate layers is used in the packaging materials produced for storing and preservation all kinds of dust and granular material such as cement, building chemicals, flour, starch. The materials forming the respective intermediate layer have air-permeable perforations. However, when the product in the form of powder/granule is filled into the storage sacks which are made of kraft paper and having a perforated interlayer structure, the micron-sized powder and granule pieces are disintegrated from the kraft paper to the outside, and outer surface of the storage sacks produced from kraft paper is coated with the respective powder and/or granule pieces, ie outing is observed on the outer surface of the storage sacks.

Transportation of the storage sacks of the outer surface, which are made of paper and coated with dust and/or granular parts, arise problems and do not create a healthy appearance. For these reasons, it can occur during storage in time, which prevents outing on the outer surface of the filling package and prevents moisture occurring on the outer and outer surfaces in time; there is a need for a sack that prevents product deterioration.

In document no TR200809886, a strengthened packaging, protection, coating material is mentioned. In the present invention, a coating, storage product comprising a strength-enhancing fibrous material is formed between the two layers selected from paper, nylon aluminum foil. In one embodiment of the invention, the respective coating product is used as cement sack or cling nylon.

In document no TR201100122, production of a sack with a single-layer appearance is mentioned. In the present invention, the resulting sack is obtained by reducing the kraft paper between 4 g and 60 g/m2 to 110 g/m2 and/or the polyethylene structure to 2 to 3 layers. The sack production according to the invention is environmental and economical.

In document no TR201112683, an insulated packaging material is mentioned. The present invention relates to a package or container containing a side wall. The side wall of the invention has an inner surface and an outer surface. An insulating material is applied in at least one of the inner or outer surfaces of the side wall.

In document no U.S. Pat. No. 4,316,574, a flexible paper sack suitable for containing granular products comprising an improved valve adapted to receive the filling end of a product dispensing machine at one corner of one end thereof. The valve according to the invention comprises a tubular plastic sleeve disposed in an orifice between the opposite hinged lower edges of the sack. One end of the sleeve valve extending into the sack and suspended freely serves as a self-sealing valve during sack filling. Sliding the product in the sack after filling closes the sleeve valve by folding the sleeve to itself.

In document no U.S. Pat. No. 4,132,347, a cement sack with a blowing slot in a corner of its upper end is mentioned. In the present invention, the top end of the sack is stitched to close the sack. Both sides of the sack mentioned in the invention are closed by stitching to form a pocket. In addition, the sides of this sack are folded in V form and the upper and lower bases are stitched.

### BRIEF SUMMARY OF THE INVENTION

A purpose of the present invention is to create a sack which is composed of more than one intermediate layer and between the intermediate layers, allowing the air inside the kraft sack to exit to the external environment during the filling of the material and to store and preserve the physical and chemical properties of the products in powder and/or granular form unchanged.

Another object of the present invention is to provide a sack which prevents the external outing during the discharge of air from the perforation holes of the raw and/or granular raw materials during the filling of the air, ie the dust particles to be not visible on the outer surface.

Another object of the present invention is to provide a sack for shortening the filling time.

Another object of the present invention is to provide a sack that enables the layers forming the kraft sack to rapidly evacuate the air without the need for perforation, ie, air evacuation holes, and to provide a barrier to moisture.

### BRIEF DESCRIPTION OF THE SEVERAL VIEWS OF THE DRAWINGS

“A Sack” that was created for achieving intention of this invention was demonstrated in the enclosed figures, and they consist of:

FIG. 1 is a side profile detailed view of a sack according to the invention.

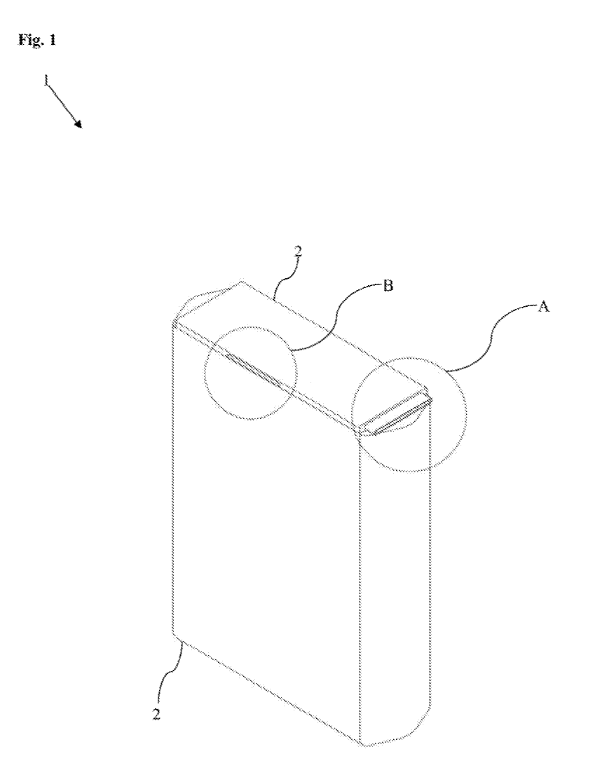

FIG. 2 is the detailed view of A in a sack according to the invention.

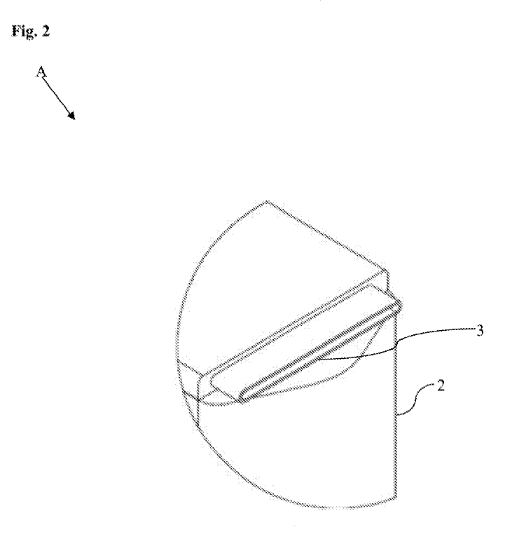

FIG. 3 is the detailed view of B in a sack according to the invention.

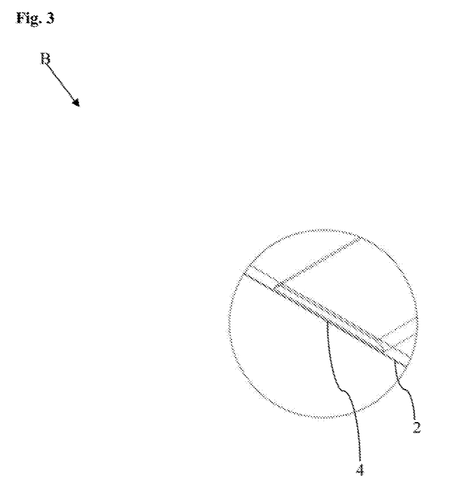

FIG. 4 is the unfolded view of the lower and upper parts of a sack according to the invention.

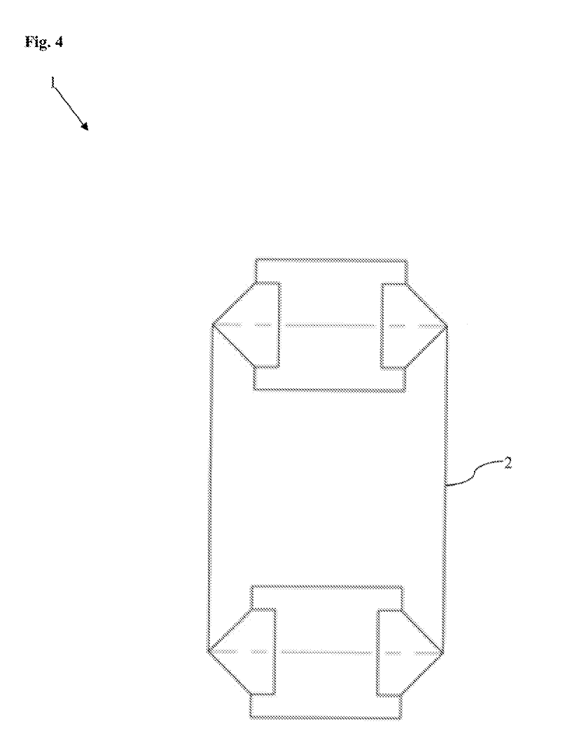

FIG. 5 is the folded view of the lower and upper parts of a sack according to the invention.

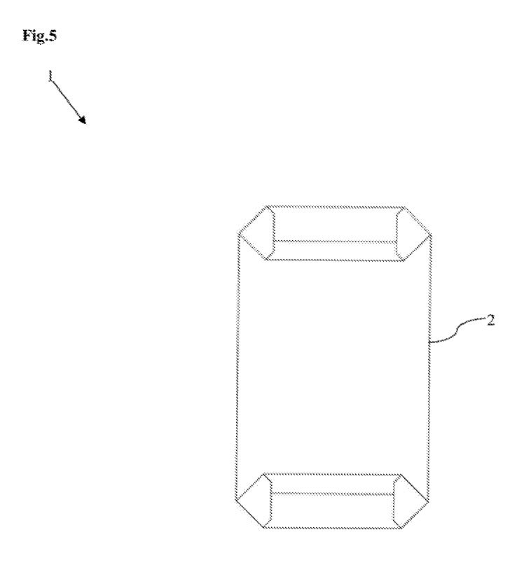

FIG. 6 is the view of the filling orifice and the discharge duct in a sack according to the invention.

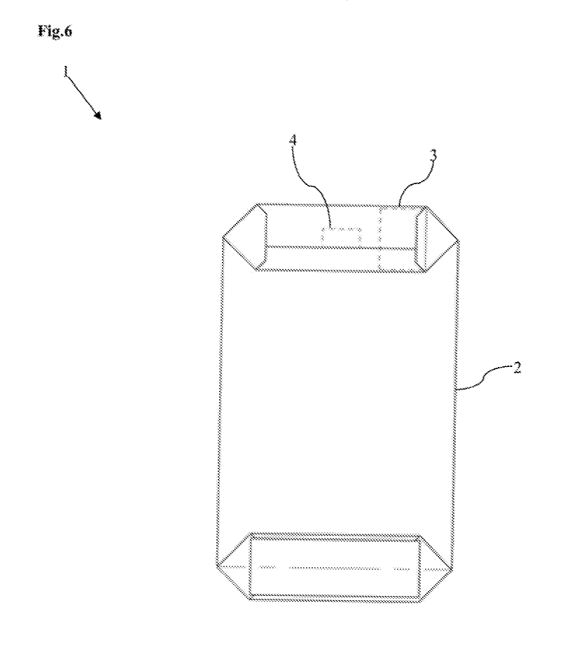

FIG. 7 is the detailed view of the discharge duct in a sack according to the invention.

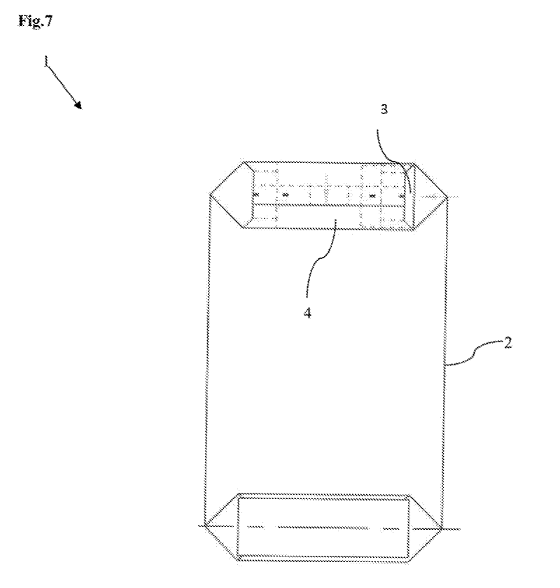

FIG. 8 is a detailed view of the filling orifice in a sack of according to the invention.

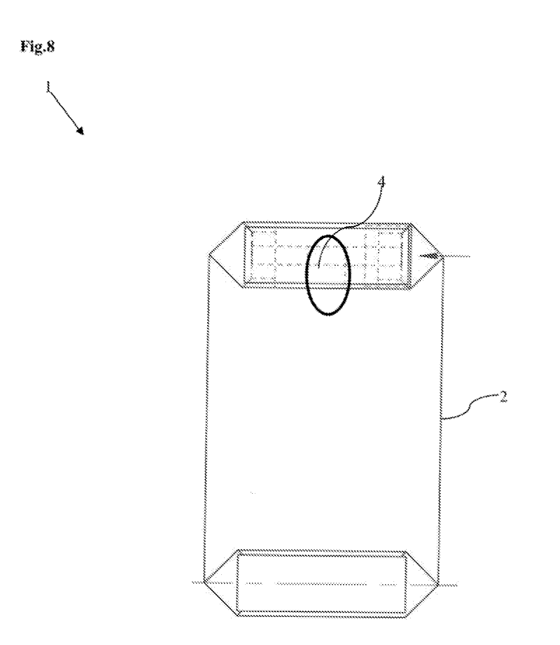

FIG. 9 is a detailed view of the layers in a sack according to the invention.

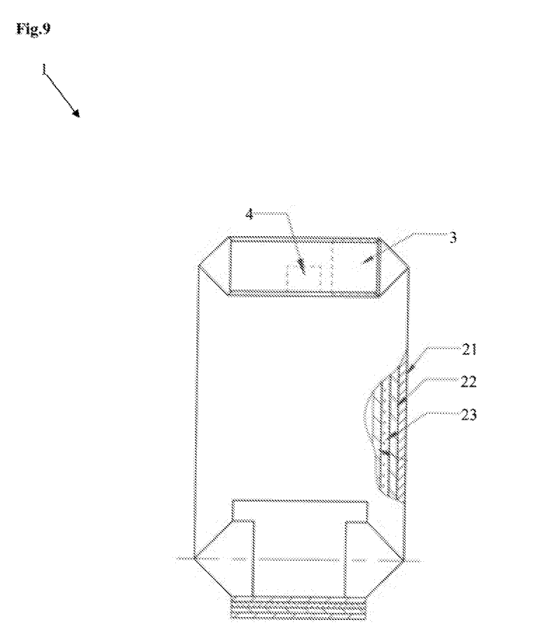

Parts included in the figures are individually enumerated and their equivalents were provided below.
1. Sack
2. Body
21. First layer
22. Second layer
23. Third layer
3. Filling orifice
4. Discharge duct

### DETAILED DESCRIPTION OF THE INVENTION

A sack (1) according to the invention comprises:

at least one body (2) which provides filling and storage of the material or product in the interior of the articles or products in the form of powder and/or granule;

at least a first layer (21), which is preferably made of a tear-resistant material forming the outer part of the body (2);

at least a second layer (22) providing additional strength to the body (2) on the inner surface of the layer (21);

at least a third layer (23) of the inner surface of the second layer (22), which is preferably made of an air-permeable material, which forms the innermost side of the body (2);

at least one filling orifice (3) providing the filling of the material or product in powder and/or granular form into the cavity in the body (2) at the top of the body (2);

at least one discharge duct (4) which, when filling the material in the powder and/or granular form made from the filling opening (3) of the air inside the body (2) on the top of the body (2), and from the filling orifice (3) part.

In the preferred embodiment of the invention, the body (2) maintains its moisture inside the material in powder and/or granular form which is filled into it. The body (2) is formed by sticking the first layer (21), the second layer (22) and the third layer (23) together. The body (2) consists of at least three layers.

In addition, the body (2) can be manufactured as multi-layer as its structure, suitable for the packaging forms and structures, material density and external factors used in the present, and ensures that the material in the powder and/or granular form is kept securely until it reaches the end user.

In another embodiment of the present invention, when we want to form the body (2) from 2 to 6 layers, kraft paper with polyethylene laminated kraft, kraft paper with aluminum foil or similar laminated kraft papers can be positioned in the most inner layer or the outermost layer. When we use the body (2) as 2 or 6 multi-layer, the first layer is the fastest permeable kraft paper on the inner layer where the product comes into contact, the second layer is hdpe (high density polyethylene-high density polyethylene), ldpe (low density polyethylene-low density polyethylene), mdpe (medium density polyethylene), laminated polyethylene, aluminum foil kraft and third and later layers are preferred as kraft paper.

In one embodiment of the present invention, the first layer (21) is made of kraft paper or high porosity paper which can rapidly evacuate the air.

In the preferred embodiment of the present invention, the second layer (22) is located between the first layer (21) and the third layer (23). The second layer (22) comprises at least one or all of different types of paper, such as hdpe, ldpe, mdpe, polyethylene, aluminum foil kraft, or laminated kraft, and has a tubular structure that is glued on each other. Perforation and punch holes are not available on the surface of the second layer (22). Since the second layer (22) does not have perforation and punch holes on its surface, it prevents the powder and/or granular material from overflowing out of the body (2) and the outing outside the body (2).

In addition, the second layer (22) has an oxygen barrier property within the structure of the polyethylene and also prevents odor and moisture permeability.

In the preferred embodiment of the invention, the third layer (23) contacts the material or product in powder and/or granular form which is filled into the body (2). The third layer (23) rapidly transfers the air contained in the powder and/or granular material filled into the body (2) to the second layer (22). The third layer (23) provides fast and without outing into the body (2) without the need for punching holes and perforation due to the high porosity paper. In addition, the third layer (23) enables the filling of the body (2) to ensure that the material in the powder and/or granular form filled into the body (2) is protected against internal and external influences without altering its physical, chemical properties.

In the preferred embodiment of the present invention, the filling orifice (3) is an aperture at the top of the body which is hexagonal.

In the preferred embodiment of the invention, the discharge duct (4) is a hollow pocket extending up to the upper part of the body (2) which is stretched to the hexagonal shape of the body (2) and in the filling orifice (3) part. The discharge duct (4) is used to eliminate the negative effect of the material in the form of powder and/or granular which is filled into the body (2) to the filling time since there is no perforation and punch holes in the surface of the second layer (23). The discharge duct (4) provides a faster filling of the material in the form of powder and/or granule passing through the filling orifice (3) into the body (2), i.e. shortening the filling time by draining the air remaining in the body (2).

In a sack (1) according to the invention, the first layer (21), the second layer (22) and the third layer (23) are joined together to form the body (2). The first layer (21) forms the outermost side and/or part of the body (2). In the first layer (21), preferably kraft paper is used.

The second layer (22) is located in the portion between the first layer (21) and the third layer (23). In the second layer (22), papers containing different types, such as polyethylene hdpe, ldpe, mdpe, polyethylene, aluminum foil kraft, or laminated kraft, are used which do not have perforation and punch holes, and the materials used are folded and sticked on top of each other and thus form the tube. Since the second layer (22) does not have perforation and punch holes on its surface, it prevents the powder and/or granular material from overflowing out of the body (2) and the outing outside the body (2) and moisture permeability. However, the second layer (22) has an oxygen barrier property within the structure of the polyethylene and also prevents odor permeability.

The third layer (23), which is the last layer forming the body (2), is also located on the inside of the second layer (22), ie in contact with the powder and/or granular material which is filled into the body (2). The third layer (23) enables the filling of the body to ensure that the material in the powder and/or granular form filled into the body (2) is protected against internal and external influences without altering its physical, chemical properties. Further, a filling orifice (3) is provided in the upper part of the body (2) to provide filling of the material in powder and/or granular form into the cavity in the body (2). A discharge duct (4) is used to discharge air from the filling (3) into the body (2) in powder and/or granular form while the air in the body (2) is discharged. Discharge duct (4) is a hollow pocket which extends to the upper part of the body (2) which is stretched to the hexagonal shape of the body (2).

As a result, with a sack (1) according to the invention, internal air is provided to the outside when the material is filled in the interior of the ventilation channel with a ventilation channel between the intermediate layers, consisting of more than one intermediate layer and the physical and chemical properties of the products in powder and/or granular form are kept unchanged and stored. In addition, whit this sack (1), it is prevented that the external outing during the discharge of air from the perforation holes of the raw and/or granular raw materials during the filling of the air, ie the dust particles to be not visible on the outer surface.

It is possible to develop various applications for a sack (1), subject of invention, it may not be limited to examples described here, it is essentially as described in claims.

I claim:

1. A sack having at least one body which provides filling and storage of the material or product in the interior of the articles or products in the form of powder and/or granule;
at least a first layer, which is preferably made of a tear-resistant material forming the outer part of the body;
at least a second layer providing additional strength to the body on the inner surface of the first layer;
at least a third layer of the inner surface of the second layer, which is preferably made of an air-permeable material, which forms the innermost side of the body;
at least one filling orifice providing the filling of the material or product in powder and/or granular form into the cavity in the body at the top of the body; and
wherein at least one discharge duct which, when filling the material in the powder and/or granular form made from the filling opening of the air inside the body on the top of the body, and is located on the side of the body.

2. A sack according to claim 1, characterized in that the body protects the moisture inside the material in the powder and/or granular form which is filled into the cavity.

3. A sack according to claim 1, characterized in that the body is formed by sticking the first layer, the second layer and the third layer together.

4. A sack according to claim 1, characterized in that the body comprises at least three layers.

5. A sack according to claim 1, characterized in that the first layer is made of a kraft paper capable of fast evacuation of any kind of kraft paper or air.

6. A sack according to claim 1, characterized in that the second layer is located between the first layer and the third layer.

7. A sack according to claim 1 characterized in that the second layer has at least one or all of the different types of paper such as polyethylene, aluminum foil kraft, or laminated kraft such as HDPE, Ldpe, Mdpe, and a tube-shaped structure.

8. A sack according to claim 1, characterized in that the second layer has no perforation and punch holes on its surface.

9. A sack according to claim 8, characterized in that the second layer does not have perforation and punch holes on its surface, it prevents the powder and/or granular material from overflowing out of the body and the outing outside the body.

10. A sack according to claim 9, characterized in that the second layer that prevents odor and moisture permeability by means of the oxygen barrier materials contained within the polyethylene.

11. A sack according to claim 1, characterized in that the third layer is a third layer in contact with the material or product in powder and/or granular form which is filled into the body.

12. A sack according to claim 11, characterized in that the third layer which conveys the air contained in the powder and/or granular form material filled into the body rapidly to the second layer.

13. A sack according to claim 1, characterized in that the third layer provides fast and without outing into the body without the need for punching holes and perforation due to the high porosity paper.

14. A sack according to claim 13, characterized in that the third layer enables the filling of the body to ensure that the material in the powder and/or granular form filled into the body is protected against internal and external influences without altering its physical, chemical properties.

15. A sack according to claim 1, characterized in that a filling orifice through an orifice in the upper part of the body which is hexagonal.

16. A sack according to claim 1, characterized in that the discharge duct has a hollow pocket extending from the bottom of the body to the base of the body which is stretched to the hexagonal shape of the body.

17. A sack according to claim 16, characterized in that the discharge duct is used to eliminate the negative effect of the material in the form of powder and/or granular which is filled into the body to the filling time since there is no perforation and punch holes in the surface of the second layer.

18. A sack according to claim 1, characterized in that the discharge duct provides a faster filling of the material in the form of powder and/or granule passing through the filling orifice into the body, i.e. shortening the filling time by draining the air remaining in the body.
